(19) United States
(12) Patent Application Publication
(10) Pub. No.: US 2013/0066722 A1
(43) Pub. Date: Mar. 14, 2013

(54) SYSTEM AND METHOD FOR PROVIDING ADVANCED AND REAL TIME MOBILE MARKETING VIA SMS

(71) Applicant: Thomas Khedher Alkatib, Farmington Hills, MI (US)

(72) Inventor: Thomas Khedher Alkatib, Farmington Hills, MI (US)

(21) Appl. No.: 13/613,055

(22) Filed: Sep. 13, 2012

Related U.S. Application Data
(60) Provisional application No. 61/534,385, filed on Sep. 13, 2011.

(51) Int. Cl. G06Q 30/02

(52) U.S. Cl. 705/14.64

(57) ABSTRACT

The present invention generally relates to mobile marketing techniques. Specifically, this invention relates to a system and method for providing advanced and real time (or near real-time) mobile marketing means through SMS messages. Numerous methods are described herein for the provision of and functionalities provided by one or more mobile marketing networks.

### CROSS REFERENCE TO RELATED APPLICATIONS

This application claims the benefit of U.S. Provisional Patent Application No. 61/534,385 filed Sep. 13, 2011, the entire disclosure of which is incorporated herein by reference.

### FIELD OF THE INVENTION

The present invention generally relates to mobile marketing techniques. Specifically, this invention relates to a system and method for providing advanced and real time (or near real-time) mobile marketing means through SMS messages. Numerous methods are described herein for the provision of and functionalities provided by one or more mobile marketing networks.

### BACKGROUND

Customer loyalty systems are typically operated by merchants to aid in increasing business and improving customer relationships. As expected, customer loyalty systems have improved over the years. An example of a prior art customer loyalty system traditionally enrolls customers into a customer loyalty program and customers earned incentives (e.g., points, discounts, miles) for purchases made using the customer loyalty program. When customers accumulate incentives (e.g., points, discounts, miles) they typically redeemed them for rewards. The disadvantages with this type of loyalty system are that customers may only earn incentives when they themselves made a purchase. To overcome the disadvantages of the previously described loyalty system, a new referral based loyalty system was developed and utilized by a variety of different industries. The referral based loyalty system promised customers the ability to earn additional incentives for referring new customers.

The main focus of the referral based loyalty systems was to award existing customers for enrolling new customers into the loyalty system. The loyalty system customers were still given incentives for purchases as before and were promised an incentive for referring new customers. However, disadvantages still overwhelmed this type of referral based loyalty system.

Customers typically became unmotivated to refer new business and many customers did not want to refer friends and family in return of a very small incentive to be earned. To overcome the disadvantages of the previously described referral based loyalty system, an improved incentive referral based loyalty system was developed and utilized by a variety of different industries.

Improved referral based loyalty system promised customers the ability to earn additional incentives for referring new customers, and promised to provide a bonus incentive to new customers if they were referred by existing customers. The main focus of the improved referral based loyalty system was to award existing customers for enrolling new customers into the loyalty system and to also provide a motivation to the existing customer to refer a friend or relative by enticing them with a generous incentive bonus that the new member would also earn for becoming a member.

Customers were appreciative for earning incentives and rewards for referring new customers to the loyalty system, and were also appreciative that their referral also benefited from becoming a member. In spite these improvements; disadvantages still trouble this type of improved referral based loyalty system, customers were unenthusiastic for only receiving incentives for direct referrals.

Therefore, there is need in the art for a superior customer loyalty system designed to motivate existing customers into referring new business to a merchant. These and other features and advantages of the present invention will be explained and will become obvious to one skilled in the art through the summary of the invention that follows.

### SUMMARY OF THE INVENTION

Accordingly, it is an aspect of the present invention to provide a system and method for easy and intuitive viewing of items to be ordered by a user. In particular, embodiments of the present invention are directed to providing a three dimensional shopping cart for use in ecommerce and other web-based ordering and shopping systems.

According to an embodiment of the present invention, a system for providing advanced mobile marketing via SMS includes: an application server comprising a processor, computer-executable code stored in non-volatile memory and a communications means, wherein said processor, said computer-executable code and said communications means are operably connected and are configured to: receive a SMS message received from a SMS messaging provider, wherein said SMS message is comprised of one or more of a short code ID, a merchant ID, a product ID, a label, a keyword and a data message content; process said SMS message; generate a response SMS message; and transmit said response SMS message to one or more recipients.

According to an embodiment of the present invention, the short code ID identifies an action to be taken by said application server.

According to an embodiment of the present invention, the merchant ID identifies a merchant associated with said SMS message.

According to an embodiment of the present invention, the product ID identifies a product associated with said SMS message.

According to an embodiment of the present invention, the label identifies a merchant name.

According to an embodiment of the present invention, the label identifies a product name.

According to an embodiment of the present invention, the keyword identifies an action to be taken by said application server.

According to an embodiment of the present invention, the data message content identifies data associated with said SMS message.

According to an embodiment of the present invention, the response SMS message indicates a response to said SMS message received by said application server.

According to an embodiment of the present invention, a method for providing advanced mobile marketing via SMS, includes the steps of: receiving a SMS message, at an application server, received from a SMS messaging provider, wherein said SMS message is comprised of one or more of a short code ID, a merchant ID, a product ID, a label, a keyword and a data message content; processing said SMS message; generating a response SMS message; and transmitting said response SMS message to one or more recipients.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a flow diagram of a prior art loyalty system designed to reward customers for purchases.

FIG. 2 is a flow diagram of a prior art loyalty system designed to reward customers for purchases and referrals.

FIG. 3 is a flow diagram of a prior art loyalty system designed to reward existing customers for referring new customers to the system and reward referrals for enrolling.

FIG. 4 is an architectural diagram illustration an exemplary configuration according to an embodiment of the present invention.

FIG. 5 is an architectural diagram illustrating an alternative exemplary configuration according to an embodiment of the present invention.

FIG. 6 is an architectural diagram illustrating another exemplary configuration according to an embodiment of the present invention.

FIG. 7 is a process flow illustrating an exemplary method according to an embodiment of the present invention.

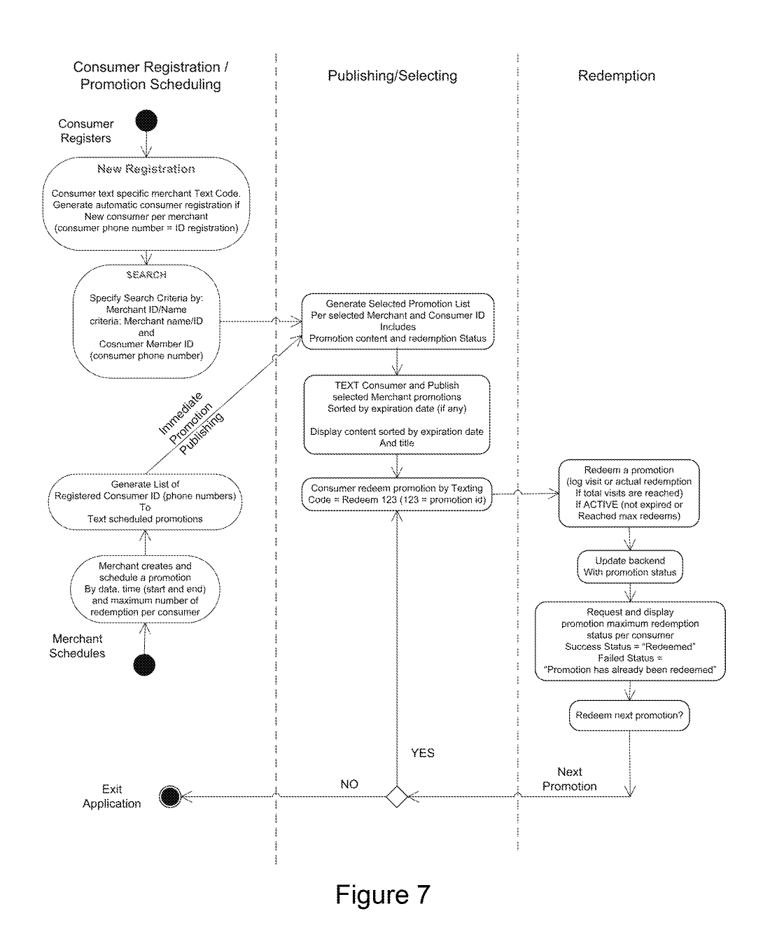

FIG. 8 is a data flow diagram illustrating an exemplary flow of data transmissions according to an embodiment of the present invention.

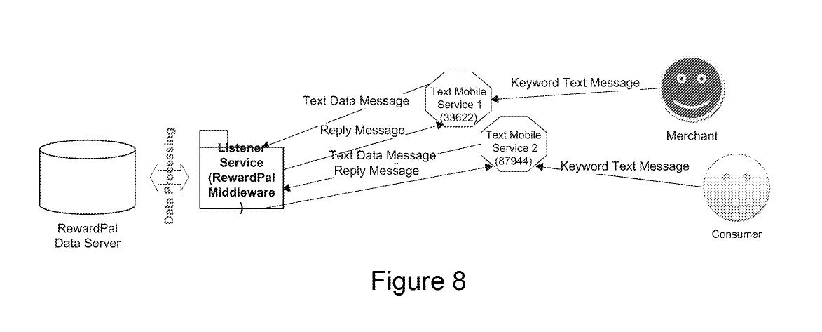

FIG. 9 is a process flow illustrating an exemplary method according to an embodiment of the present invention.

FIG. 10 is a process flow illustrating an exemplary method according to an embodiment of the present invention.

FIG. 11 is a process flow illustrating an exemplary method according to an embodiment of the present invention.

### DETAILED SPECIFICATION

As used herein, the term “virtual credit” refers to the ability to earn credit through indirect referrals.

As used herein the term “incentive” refers to rewards earned by loyalty system customers, in example, points, credits, bonuses, miles, cash discounts, etc.

As used herein, the term “referral network” refers to all the referrals, both direct referrals and/or indirect referrals, linked or associated to a specific customer.

As used herein, Short Message Service (SMS) is a text messaging service component of phone, web, or mobile communication systems, using standardized communications protocols that allow the exchange of short text messages between fixed line or mobile phone devices. When referring to text messaging herein, one or ordinary skill in the art would appreciate that the term is used in relation to or conjunction with SMS.

As used herein, the term “thin client application” refers to a client computer or client software in client-server architecture networks which depends primarily on the central server for processing activities, and mainly focuses on conveying input and output between the user and the remote server.

As used herein, the term “database” refers to a structured collection of records or data that is stored in a computer so that a computer program can consult it to answer queries.

As used herein, the term “database server” refers to a computer program that provides database services to other computer programs or computers, as defined by the client-server model. The term may also refer to a computer dedicated to running such a program.

As used herein, the term “application server” refers to a software engine that delivers applications to client computers or devices. Moreover, an application server handles most, if not all, of the business logic and data access of the application (a.k.a. centralization).

Overview

In general, the present invention describes a multi-level referral based loyalty system and method. According to an embodiment of the present invention, the system and method is accomplished through the use of one or more computing devices. One of ordinary skill in the art would appreciate that a computing device appropriate for use with embodiments of the present application may generally be comprised of one or more of a Central processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks), wide area networks (WANs) (e.g., the Internet), mobile networks (e.g., CDMA, GSM) or any combination thereof. In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

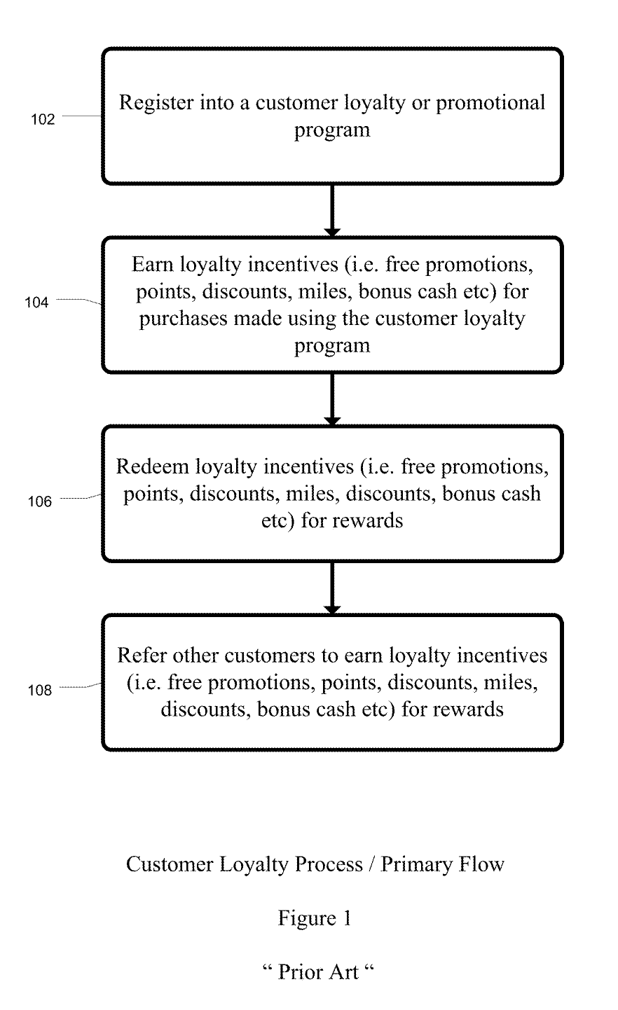

An example of a prior art loyalty system is shown in FIG. 1. Traditionally, a prior art loyalty system enrolls a customers into a customer loyalty program 102 and customers earn incentives (i.e. points, discounts, miles, etc) for purchases made using the customer loyalty program 104. When incentives are met, customers redeem incentives (i.e. points, discounts, miles, etc) for rewards 106.

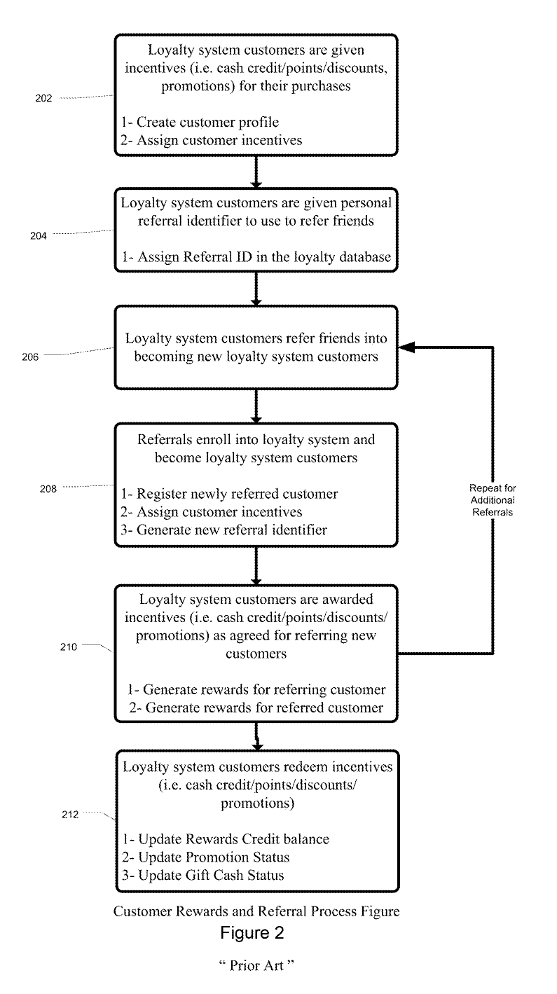

An example of a prior art loyalty system is shown in FIG. 2. Customarily, a prior art referral based loyalty system is designed to award existing customers for enrolling new customers into the loyalty system. As described in FIG. 2, the loyalty system customers are given incentives (i.e. points/discounts) for purchases 202, loyalty system customers are given referral cards to use to refer family & friends 204, and most importantly, loyalty system customers are promised an incentive (i.e. points/discounts) for referring new customers 206.

Then, loyalty system customers refer family & friends into becoming new loyalty system customers 208, their respective referrals enroll into loyalty system and become new loyalty system customers 210, and loyalty system customers are awarded incentives (i.e. points/discounts) as agreed for referring new customers 212.

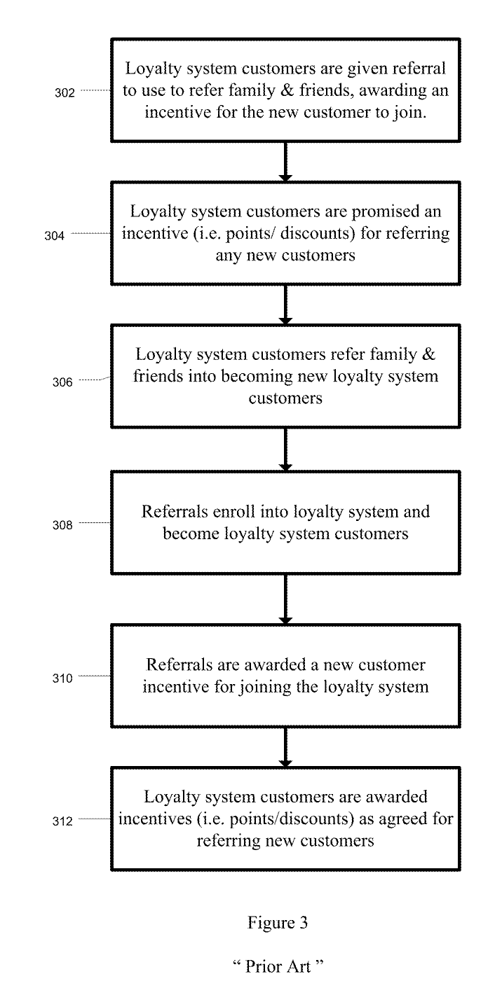

An example of a prior art loyalty system is described in FIG. 3. Usually, a prior art incentive based referral loyalty system is designed to award both the existing customer and the new customer for referring a business to a new consumer. As described in FIG. 3, loyalty system customers are given referral to use to refer family & friends, awarding an incentive for the new customer to join 302 and loyalty system customers are promised an incentive (i.e. points/discounts) for referring any new customers 304. Then, loyalty system customers refer family & friends into becoming new loyalty system customers 306, referrals enroll into loyalty system and become loyalty system customers 308. Furthermore, referrals are awarded a new customer incentive for joining the loyalty system 310 and also loyalty system customers are awarded incentives (i.e. points/discounts) as agreed for referring new customers 312.

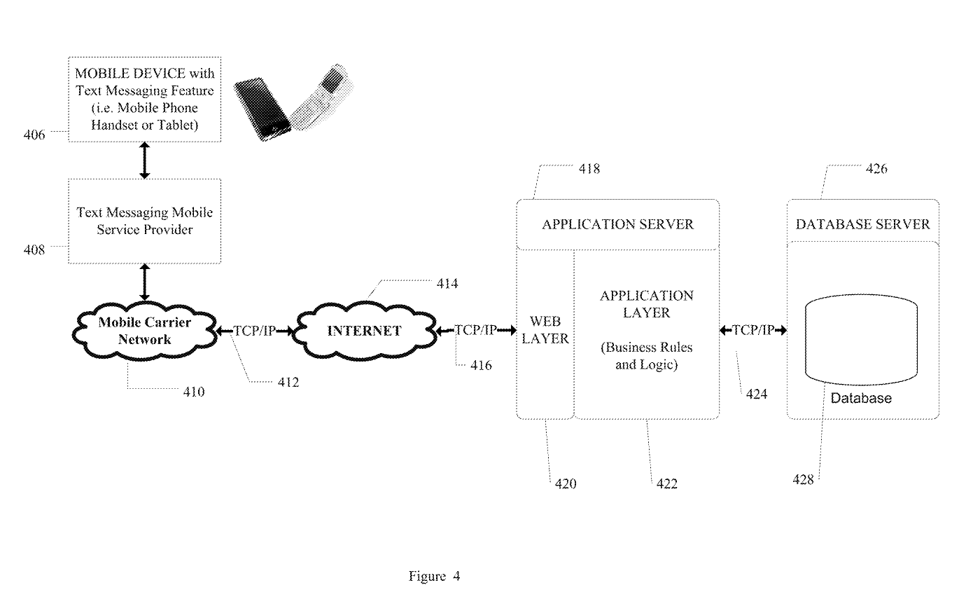

FIG. 4 illustrating an architectural diagram of a SMS loyalty system, utilizing a central server architectural provided over one or more mobile carrier networks 410. In this embodiment, a mobile device 406 communicates a transaction by means of a Text Messaging Mobile Service provider (SMS Provider) 408. SMS Provider 408 utilizes one or more mobile carrier networks to communicate with a wide area network (WAN) (e.g., the Internet 414). This conversion can be carried out by way of one or more TCP/IP communication links 412. The internet (i.e., the most identifiable and readily accessible WAN) 414 also communicates the transaction by mean of one or more TCP/IP communication links 416 to the respective application server 418 for processing. The application server 418 comprises the web layer 420 and the application layer 422. The web layer 420 comprises a set of web services and defines business functions. The application layer 422 provides semantic conversion between associated application processes. The application server 418 communicates by means of TCP/IP 424 to the database server 426. The database server 426 comprises the database 428 to process and store transaction data. The database server 426 sends a response by means of TCP/IP link 424 to the application server 418, which in turn sends a response by means of TCP/IP 416 through the internet 414. The response travels through the internet 414 and the response travels by the use of TCP/IP 412 to the mobile carrier network 410 to confirm the transactions previously sent to the database server 426 for processing and storage of transaction data.

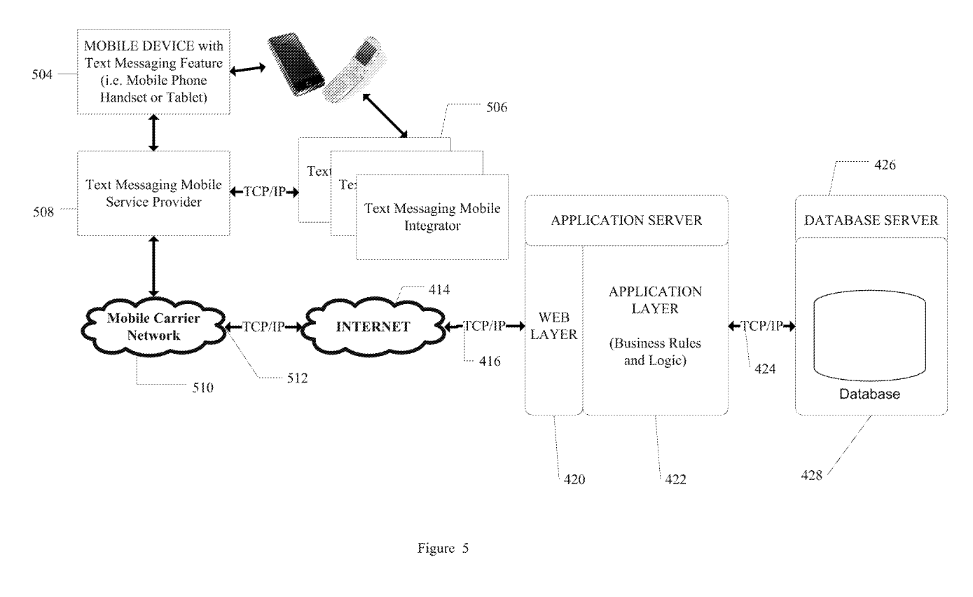

FIG. 5 illustrates a multi-merchant loyalty system, wherein utilizing a central server architectural. Mobile Device(s) 504, Text Messaging Mobile Service Provider 508 and Text Messaging Mobile Integrator 506 communicate by means of Mobile Carrier Network 510 and TCP/IP connection means 512 to the internet 414 to facilitate a response from the database 428. The internet 414 communicates the customer transaction by mean of TCP/IP communication link 416 to the respective application server 418 for processing. The application server 418 comprises the web layer 420 and the application layer 422. The web layer 420 comprises a set of web services and defines business functions. The application layer 422 provides semantic conversion between associated application processes. The application server 418 communicates by means of TCP/IP 424 to the database server 426. The database server 426 comprises the database 428 to store transactions data. The database server 426 sends a response by means of TCP/IP link 424 to the application server 418, which in turn sends a response by means of TCP/IP 416 through the internet 414. The response travels through the internet 414 and the response travels by the use of TCP/IP 412 to the thin client application 410 to confirm the receipt of transactions previously sent to the database server 426 for storage of transaction data.

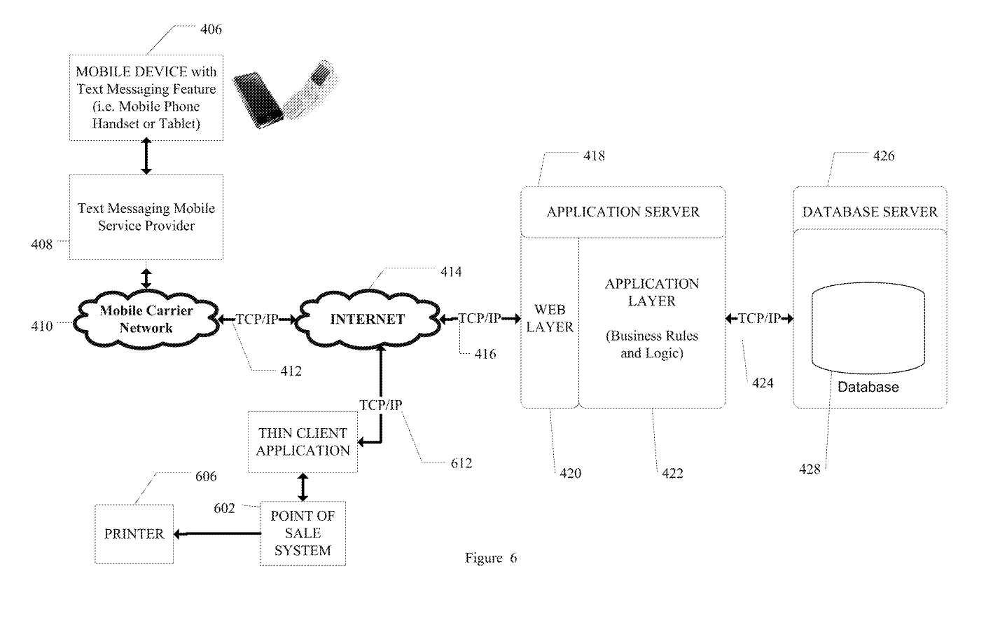

FIG. 6 illustrates a SMS loyalty system utilizing a central server architectural provided over one or more mobile carrier networks 410. In this embodiment, a mobile device 406 communicates a transaction by means of a Text Messaging Mobile Service provider (SMS Provider) 408. SMS Provider 408 utilizes one or more mobile carrier networks to communicate with a wide area network (WAN) (e.g., the Internet 414). This conversion can be carried out by way of one or more TCP/IP communication links 412. The internet (i.e., the most identifiable and readily accessible WAN) 414 also communicates the transaction by mean of one or more TCP/IP communication links 416 to the respective application server 418 for processing. The application server 418 comprises the web layer 420 and the application layer 422. The web layer 420 comprises a set of web services and defines business functions. The application layer 422 provides semantic conversion between associated application processes. The application server 418 communicates by means of TCP/IP 424 to the database server 426. The database server 426 comprises the database 428 to process and store transaction data. The database server 426 sends a response by means of TCP/IP link 424 to the application server 418, which in turn sends a response by means of TCP/IP 416 through the internet 414. The response travels through the internet 414 and the response may then travel by the use of 1) TCP/IP 412 to the mobile carrier network 410 to confirm the transactions previously sent to the database server 426 for processing and storage of transaction data and/or 2) through TCP/IP 612 to a thin client application then to a point of sale system 602 and finally to a printer 606 to confirm the transactions previously sent to the database server. By allowing the interactions to flow from the mobile device, via SMS, to a point of sale system 602 (or vice versa), customers or merchants can initiate transactions on either a mobile device or a point of sale system and have the transaction effect a result on the other device/system.

Operations

According to an embodiment of the present invention, the systems and methods herein described are configured to enable real-time business to consumer (B to C) loyalty services and business to business (B to B) Mobile Marketing via SMS text messaging engine integration with any third party SMS Messaging API. In this manner, the systems and methods herein described are configured to establish a universal and common set of SMS Keywords to be utilized by any merchant or product for SMS marketing of rewards, loyalty and promotional services.

These systems and methods are configured to provide full life cycle of real-time cash or points rewards, promotion management and gift management, customer to customer (C to C) referral management and donation management utilizing a 100% pure SMS messaging mobile channel interaction and real-time processing via text messaging without the need to utilize any mobile websites or mobile apps. In this manner, low-bandwidth simple text messages can be used to achieve full-fledged business transactions without the need for smartphones or other high-powered mobile devices.

SMS Marketing Commercial Services

According to an embodiment of the present invention, the systems and methods herein described may be configured to provide direct marketing capabilities for B to C or B to B communications. In this manner, merchants and consumers can engage directly via SMS communications with business logic processing and transactional support being handled on the backend via one or more application servers and/or database servers.

SMS Loyalty Marketing

According to an embodiment of the present invention, the systems and methods herein described may be configured to provide integration services with multiple SMS mobile operators and multiple SMS Short Codes. In this manner, the systems and methods herein described are configured to provide a SMS marketing platform that can integrate with other SMS mobile operators and aggregators to enhance consumer service offering for SMS rewards, loyalty, promotions and donation management.

SMS Loyalty Marketing Detailed Offering

According to an embodiment of the present invention, the system and methods herein described are configured to provide integration of real-time (or near real-time) loyalty web services with SMS Messaging providers or web services calls and mobile payment providers to provide the following:
generate and manage mobile consumer registration;
merchant real-time (or near real-time) promotions scheduling and management;
real-time promotion processing and redemption management;
rewards processing and redemption management;
gift incentives management (C to C) and gift cash management (B to C);
referral management (C to C) with cash rewards incentives;
non profit donation management via mobile billing or secured connection with credit card info; and
analytics interface to Twilio SMS engine or others.

SMS Marketing Technical Requirements

According to an embodiment of the present invention, the system may be comprised of one or more web service (business logic middleware) that receive and parse strings or other data formats in order to handle transactions received from external sources. For instance, via one or more routes, the one or more web services are configured to receive and process individual text messages received on an on demand basis from one or more sources. In an exemplary embodiment, the web service will be multi-threaded and event driven in order to provide timely and efficient processing of transactions, received messages and other processing requirements. Additionally, the web service may be integrated with a middleware and data model.

According to an embodiment of the present invention, the web service is configured to handle any text message, including those which are undecipherable, irrelevant, malicious or simply malformed. Where a text message cannot be parsed properly in accordance with acceptable models configured in the system, the system may be configured to transmit an automatic reply with an error message or with HELP instructions if unsuccessful.

According to an exemplary embodiment of the present invention, a SMS message received from a SMS messaging provider may be comprised of one or more of a short code ID, a merchant ID, a product ID, a label, a keyword, a data message content or any combination thereof. A given SMS message may be comprised of the entire set or any subset of these elements. The following is a sample pseudo-code message:

| | |
|---|---|
| [symbol] | Structure: <Short Code ID> <Consumer phone #> <Merchant or |
| | Product ID> |
| | <Keyword + Data Message content> |
| [symbol] | Example: 33622 8002220000 12 Redeem Promo 3485 c. |

According to an embodiment of the present invention, a short code ID is assigned by mobile carrier to identify the system being utilized or any text a mobile company may be interested in linking to the system.

According to an embodiment of the present invention, a merchant ID, product ID or label is an unique ID per given to a specific merchant or product. The ID or label is used as membership registration to identify that particular product or merchant with the system herein described.

According to an embodiment of the present invention, a keyword is a short string or other data format that identifies an action or event to process. Keywords are certain actions that trigger an internal data processing in the system. The data processing occurs on the application server, database server or any combination thereof. The keywords are utilized to identify and enact certain functionality provided by the system.

According to an embodiment of the present invention, a data message content is additional data configured to identify an action or set of actions to be taken. In the case of the preceding offset example, the system is being requested to redeem Promo 3485, where 3485 is the data message content.

According to an embodiment of the present invention, the system may be comprised of a data model. The data model must be able to manage multiple short code IDs with unique keywords for each short code ID. A typical merchant may be able to utilize different short code IDs (or phone numbers) with unique keywords per short code at the same time.

Exemplary Methods

The following description details some exemplary embodiments of keywords and usage examples of each. These examples are for comprehension purposes only and should not be construed to limit embodiments of the present invention. Embodiments of the present invention are contemplated for use with any suitable keyword, and one of ordinary skill in the art would appreciate that there are numerous suitable keywords that could be utilized with embodiments of the present invention.

HELP

According to an embodiment of the present invention, the HELP keyword is configured to show all available keywords provided by the system, a particular merchant or any combination thereof. The following is a sample pseudo-code of a HELP message:

| | | | |
|---|---|---|---|
| [symbol] | Input Format: | HELP <Merchant ID> Input Example: | HELP 349 |

| [symbol] | Output Return Message Format: Text the keyword with merchant ID. BAL or | |
|---|---|---|
| | PROMO or REDEEM or GIFT. Refer your friend: text REFER 349 <friend phone | |
| | #>. Text STOP 349 to 2 opt out. | |
| [symbol] | Input Format: | HELP |

| | |
|---|---|
| [symbol] | Output Return Message Format: “Welcome to SMS Rewards. Please ask the |
| | merchant for their ID or label to gain rewards and free promotions” |

BALANCE or BAL

According to an embodiment of the present invention, the BALANCE or BAL keyword is configured to show consumer(s) real-time balance for cash rewards and real-time active promotions. The following is a sample pseudo-code of a BALANCE or BAL message:

| [symbol] | Input Format: BALANCE or BAL <Merchant ID> Input Example: | |
|---|---|---|
| | BAL 12 | |
| [symbol] | Output Example: | “Caribou Coffee: Your balance is $15 |

rewards credit. You have one free burger to redeem. To redeem
Type: RED <merchant ID>”

PROMO

According to an embodiment of the present invention, the PROMO keyword is configured to show consumers all real-time promos for a specific merchant. The system will provide to the mobile device, or other appropriate display, any and/or all promotions. The system may be configured to provide a promotion only if the promotion is within the date and time range and has not exceed the Total Redemption Limit per Customer. The system may be further configured to only show those promotions which are currently active (e.g., not suspended or terminated by a merchant). The following is a sample pseudo-code of a PROMO message:

| | |
|---|---|
| [symbol] | Input Format: PROMO <Merchant ID> Input Example: |
| | PROMO 15 |
| [symbol] | Output Example Message: “McDonald: Promo 70, Buy one burger |
| | get one free, Promo 75, FREE Ice Cream” |

REDEEM or RED:

According to an embodiment of the present invention, the REDEEM or RED keywords are utilized to provide real-time (or near real-time) service(s) for redeeming a consumer PROMO or REWARDS for the specific merchant. This real-time service can also keep track of how many redemptions each consumer has received and shut down a promotion automatically when a max redemption is reached. The system may also be configured to utilize REDEEM or RED to provide a service for rewards services where consumers can redeem their cash rewards partially or in full at any participating merchants. The following is a sample pseudo-code of a REDEEM or Red message:

| | |
|---|---|
| [symbol] | Input Message format: REDEEM or RED <Merchant ID or label> |
| | Promo <Promo ID> |
| [symbol] | Show Balance, Input Example (1): RED 839 (It will execute the |
| | BAL command and show you cash and PROMOS for merchant 839) |
| [symbol] | Input Example (2): REDEEM 839 Promo 70 (merchant id=839, |
| | Promo |
| [symbol] | REWARDS Input Example (3): REDEEM 839 24.25 (merchant |
| | id=839, rewards amount to redeem = $24.25) |

STOP

According to an embodiment of the present invention, the keyword STOP can be utilized by a consumer who wishes to opt out from receiving communications from a specific merchant. The following is a sample pseudo-code of a STOP message:

| | | |
|---|---|---|
| [symbol] | Input Message format: STOP <Merchant ID> Input Example: | STOP 3248 |

GIFT

According to an embodiment of the present invention, the GIFT keyword (or GIFT ALL) may be utilized to donate or gift some or all of a consumer's cash rewards credit in real-time to any other consumer or buy gift cash from a specific merchant. When a consumer sends a gift to someone else, some or all of the consumer's cash rewards and gift cash credits are transferred to the gifted to person. The following is a sample pseudo-code of a GIFT message:

| | | |
|---|---|---|
| [symbol] | Input Format to Gift to others: | GIFT <Merchant ID or Label> <Friends |

| | |
|---|---|
| | phone #> Input Format to purchase eGift: GIFT <Merchant ID or Label> |
| | <purchase amount> Input Example, Gift to Others: GIFT BBQNovi 7349891282 |
| | (BBQNovi = merchant name label, all cash rewards with this merchant is gifted to |
| | 7349891282 ) |
| [symbol] | Output Message Format, Gift to others. On the SENDER phone: “<merchant |
| | name>: Thank you for your business. Your GIFT has been sent to <Friends |
| | phone #>. |
| [symbol] | Output Message Format, Gift to others, sent to the Gifted friend phone: |

“WOW! you have received an eGIFT of <cash rewards or gift amount>

| | |
|---|---|
| | from your friend @ <sender phone #>. Enjoy it at the following business: |
| | <Merchant Name>. Text HELP <Merchant ID> for more info.” |
| [symbol] | Output Message Example, Purchase eGift: “WOW! you have received an eGIFT |
| | of $10.50 from your friend @ 7349891282. Enjoy it at the following business: |
| | BBQNovi. Text HELP BBQNovi for more info.” |

REFER

According to an embodiment of the present invention, the REFER keyword may be utilized to establish Consumer to Consumer (C to C) referral links per merchant for additional cash rewards. Cash rewards levels may be preconfigured or change dynamically for each merchant via a command center application utilized by the system in embodiments of the present invention. When a REFER command is executed, the referred friend will be registered or added for the selected business if the ID (phone #) does not exist. If the referred friend number exists and it is linked to this specific merchant via someone else or even via this referee consumer, then nothing will change. The current referred link for this specific merchant will not change. The following is a sample pseudo-code of a REFER message:

| | |
|---|---|
| [symbol] | Input Format: REFER <Merchant ID or label> <Referred friend Phone #> Input |
| | Example: REFER BBQNovi 7346871234 |
| [symbol] | Output Message Format to referred Friend/Consumer: Congratulations: Your |
| | friend @ <referer phone #> has referred you to join <Merchant Name> for |
| | awesome cash rewards and promotions. Check it out by texting: PROMO |
| | <Merchant ID>. To Opt Out. Text: STOP <Merchant ID> |
| [symbol] | Output Message Example: “Congratulations: Your friend @ 2487971234 has |
| | referred you to join BBQ Novi for awesome cash rewards and promotions. Check |
| | it out by texting: PROMO <Merchant ID>. To Opt Out. Text: STOP 12 ” |

GIVE or DONATE

According to an embodiment of the present invention, the GIVE and/or DONATE keywords bay be utilized to donate to one or more nonprofit organizations via a single SMS command. Mobile payments or automatic charges to a consumer's credit card may be used. The following is a sample pseudo-code of a GIVE or DONATE message:

| [symbol] | Input Format: GIVE <Merchant ID or Label> <Amount Donated> | |
|---|---|---|
| [symbol] | Input Example: | GIVE CALC 100 (CALC = nonprofit |

| | |
|---|---|
| | organization Label, donation amount = $100) |
| [symbol] | Output Message Format: “Thank You for Your Donation! Of |
| | <Amount Donated> to support our organization” |
| [symbol] | Output Message Example: “Thank You for Your Donation! Of $100 |
| | to support our organization” |

MERCHANT SAY

According to an embodiment of the present invention, the SAY keyword is used to process surveys, votes and questions from merchants to consumers. The data message is sent to all consumers that are signed up with the specific merchant and given the opportunity to respond back with a specific answer. In an exemplary embodiment 2 data tables are used in support of this functionality. One data table is used for managing all data messages per merchant. A second data table is utilized to manage customer responses for each asked question per Merchant ID including date/time stamp. The following is a sample pseudo-code of a SAY message:

| | | |
|---|---|---|
| [symbol] | Input message: | SAY <Merchant ID> <Data Message> |

| | |
|---|---|
| [symbol] | Input Message Example: SAY 12 Do you like our Sandwidth Daily |
| | Special? Answer Yes or No |
| [symbol] | Consumer Output Message: <Merchant Label>: <Data Message> |
| | Consumer Response: <Yes or No> |

ADD or UPDATE

According to an embodiment of the present invention, the ADD or UPDATE keyword provides the system the functionality to add or update a merchant or product label. In an exemplary embodiment, this keyword is only available for authorized Merchant Phone numbers. The following is a sample pseudo-code of an ADD or UPDATE message:

| | |
|---|---|
| [symbol] | Input Format: ADD <Merchant Or Product ID> LABEL <Merchant |
| | or Product Label> |
| [symbol] | Input Example (1, add new label): ADD 145 LABEL BBQNovi |
| [symbol] | Input Example (2, Update new label): UPDATE 145 LABEL |
| | BBQNovi |

REVIEW

According to an embodiment of the present invention, the REVIEW keyword may be utilized to review a Merchant or Product based on a Label. Any merchant or product description can be reviewed with the REVIEW command followed by the consumer balance and available real-time promotions that are time limited. The following is a sample pseudo-code of a REVIEW message:

| | |
|---|---|
| [symbol] | Input SMS Message: <Merchant or product or Label> |
| [symbol] | Input SMS Message Example (product label): RP7500 |
| [symbol] | Input SMS Message Example (merchant label): BBQNovi |
| [symbol] | Output SMS Message Example (product): RP7500 is a unique product with 1M pixels |
| | and RBG color printing. Promo 3485 is available today only for 50% off this product |
| | and free memory stick. Text RED RP7500 Promo 3485 to redeem. |
| [symbol] | Output SMS Message Example (merchant): BBQ Novi is the best pulled pork BBQ in |
| | town. Celebrate their tradition with domestic beer from your favorite local brewery. |
| | Promo 57 available on Tuesday's only. Kids eat free lunch and 20% off your meal. |
| | Redeemed twice per customer only. Text RED BBQNovi Promo 57 to redeem |

VISIT

According to an embodiment of the present invention, the VISIT keyword is configured to allow a consumer to check-in at their local favorite business and get rewarded for their frequent visits. According to an exemplary embodiment of the present invention, this command can be executed by the consumer or merchant. Further, according to an exemplary embodiment of the present invention, only one visit will be allowed per day. In alternate embodiments, more than one visit per day will be allowed. The challenge is to validate if the consumer is near the business location when this command is executed and especially if the consumer does not have a GPS enabled phone. Consumer number will be registered if it is first time visit. The following is a sample pseudo-code of a VISIT message:

| | |
|---|---|
| [symbol] | Input message for consumer: VISIT <Merchant ID> |
| [symbol] | Input Message for Merchant Authorized phone: VISIT <consumer |
| | phone #> |

REWARDS: SMS REWARDS PROCESSING

According to an embodiment of the present invention, the systems and methods described herein may be configured to provide a merchant the ability to send text messages to record or give away rewards credit based on one or more variables (e.g., a consumer total purchase amount). In an exemplary embodiment, the merchant texts a record rewards credit command. A new consumer record is added and the new consumer is automatically registered also for the specific merchant business. The following is a sample pseudo-code of a REWARDS message:

| | |
|---|---|
| [symbol] | Input Message Format: REWARDS <Merchant ID or label> <Consumer mobile |
| | number ID> <Purchase Amount> |
| [symbol] | Input Example: REWARDS 12 2487881234 50.98 (merchant id=12, then |
| | consumer phone number and the purchase amount is = $50.98) |
| [symbol] | Output Message Format (successful transaction): “Confirmed: Customer |
| | <Consumer mobile number ID>, purchase amount = <Purchase Amount>, |
| | rewards credit earned = < specific purchase earned rewards credit in format $$.cc |
| | > |
| [symbol] | Output Example (successful transaction): Confirmed: Customer 2487881234, |
| | purchase amount = $50.98, rewards credit earned = $3.45 |

MERCHANT REVIEW

According to an embodiment of the present invention, the merchant REVIEW keyword can be utilized to review consumer rewards credit when needed via a text keyword. The following is a sample pseudo-code of a REVIEW message:

| | |
|---|---|
| [symbol] | Input Message Format: REVIEW <Merchant ID or label> |

<Consumer mobile number ID>

| [symbol] | Input Example: REVIEW 12 2487881234 50.98 (merchant |
|---|---|
| | id=12, then consumer phone number and the purchase amount |
| | is = $50.98) |
| [symbol] | (Note: A log must be produced for all SMS transactions noted |

with this item)

MERCHANT AUTHENTICATION

According to an embodiment of the present invention, the system may be configured to allow for the pre-authorization and/or pre-programming of numbers for merchant texting. The system may be designed so that a merchant phone number table (more than one number for each merchant is possible) that is connected to a merchant ID. This merchant phone number table will be used to verify if this a number used to send a text message with a keyword is an authorized number to execute one or more MERCHANT REWARDS SMS transaction as noted above.

According to an embodiment of the present invention, the If someone unauthorized texts the above merchant message such as: REWARDS 12 2487881234 50.98 then the following ERROR is produced on the unauthorized phone and LOGGED into the table along with the unauthorized phone number:

| | | |
|---|---|---|
| [symbol] | Output Error Message: | “ERROR: This phone is not authorized |

to execute this transaction. Please contact the merchant”

MERCHANT AUTHORIZATION

According to an embodiment of the present invention, the system may be configured to only allow a merchant with a pre-authorized phone number to only to add and authorize or de-activate phone numbers for REWARDS processing for his business only. Merchants are not allowed to add phone numbers for other merchants.

According to an embodiment of the present invention, any authorized personnel, authorized merchant phone number (only one number) will be allowed to activate additional phone numbers per merchant or de-activate (disable) phone numbers per merchant. A detailed table is established to track phones numbers, date and time stamps, and activities for enabling and disabling numbers. In an exemplary embodiment of the present invention, only certain personnel will be considered authorized personnel for the purposes of adding/removing additional numbers. The following is a sample pseudo-code of a INPUT message:

| | | |
|---|---|---|
| [symbol] | Input SMS Format (adding a number): | ADD <Merchant ID or Name> <New |

Phone Number>

| [symbol] | Input SMS Example (adding a number): | ADD 12 2487881234 |
|---|---|---|
| [symbol] | Output Message Format (successful): | “<Merchant Name>: Successfully added |
| | <new phone number>” | |
| [symbol] | Input SMS Format (deleting a number): | DEL <Merchant ID or Name> <New Phone |
| | Number> | |
| [symbol] | Input SMS Example (deleting a number): | DEL 12 2487881234 |
| [symbol] | Output Message Format (successful): | “<Merchant Name>: <phone number> has |

been disabled ”

CONSUMER

According to an embodiment of the present invention, the system may be configured to provide a consumer a text message indicating the name of the merchant business and total rewards credit balance. The following is a sample pseudo-code of the aforementioned message:

| | |
|---|---|
| [symbol] | Output message format: <Merchant Name>: Congratulations! |
| | You earned <specific purchase earned rewards credit in format |
| | $$.cc > cash rewards. Your total cash rewards balance is <rewards |
| | credit TOTAL amount in digit format $$.cc> |
| [symbol] | Output Example: Jimmy John: Congratulations! You earned $5.35 |
| | today. Your total cash rewards balance is $30.45 |

According to an embodiment of the present invention, the system may be configured to provide to a consumer the ability to redeem the rewards credit at any time by via the REDEEM or RED keyword. The message format is noted in the REDEEM section above.

According to an embodiment of the present invention, the merchant may be provided with functionality to void (full or partial) any consumer rewards credit using the authorized merchant mobile phone number (VOID keyword) or merchant website.

According to an embodiment of the present invention, a merchant may utilize the SAY keyword. SAY is used to process surveys, votes and questions from merchants to consumers. The data message is sent to all consumers that are signed up with the specific merchant and given the opportunity to respond back with a specific answer. An exemplary embodiment of the present invention utilizes 2 data tables for this functionality. One data table is provided for managing all data messages per merchant. A second data table is configured to manage customer responses for each asked question per Merchant ID including date/time stamp. The following is a sample pseudo-code of the aforementioned message:

| | | |
|---|---|---|
| [symbol] | Input message: | SAY <Merchant ID> <Data Message> |

| | |
|---|---|
| [symbol] | Input Message Example: SAY 12 Do you like our Sandwidth Daily |
| | Special? Answer Yes or No |
| [symbol] | Consumer Output Message: <Merchant Label>: <Data Message> |
| | Consumer Response: <Yes or No> |

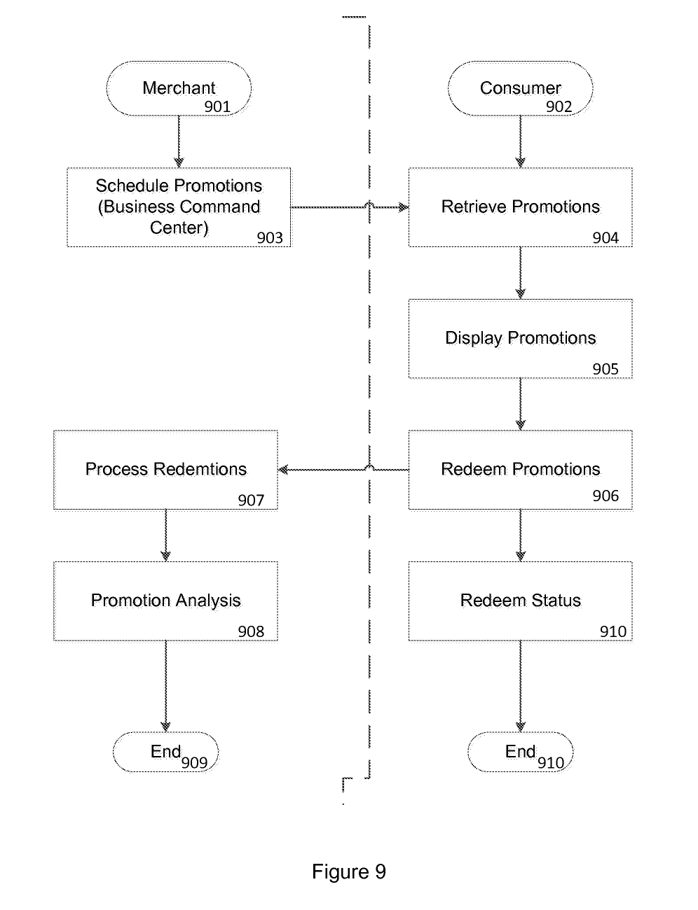

Turning now to FIG. 9, a process flow illustrating an exemplary method, according to an embodiment of the present invention, is shown. The process may be perceived to start at different steps, depending if the starting point is based on a merchant's viewpoint 901 or a consumer's viewpoint 902. Based on the merchant's viewpoint 901, the process begins at step 903 when the merchant schedules promotions, for instance through use of a business command center provided by the system. At step 904, the consumer is able to retrieve the promotions from the system as provided by the merchant. At step 905, the promotion(s) are displayed on the user's computing device. At step 906, the user can redeem the promotions. At step 907, the system processes the redemptions and the merchant can continue to analyze the promotions (step 908) at which point the process terminates for the merchant (step 909). Simultaneously, the user can redeem the status of their use of the promotions (step 910) at which point the process terminates for the user (step 910).

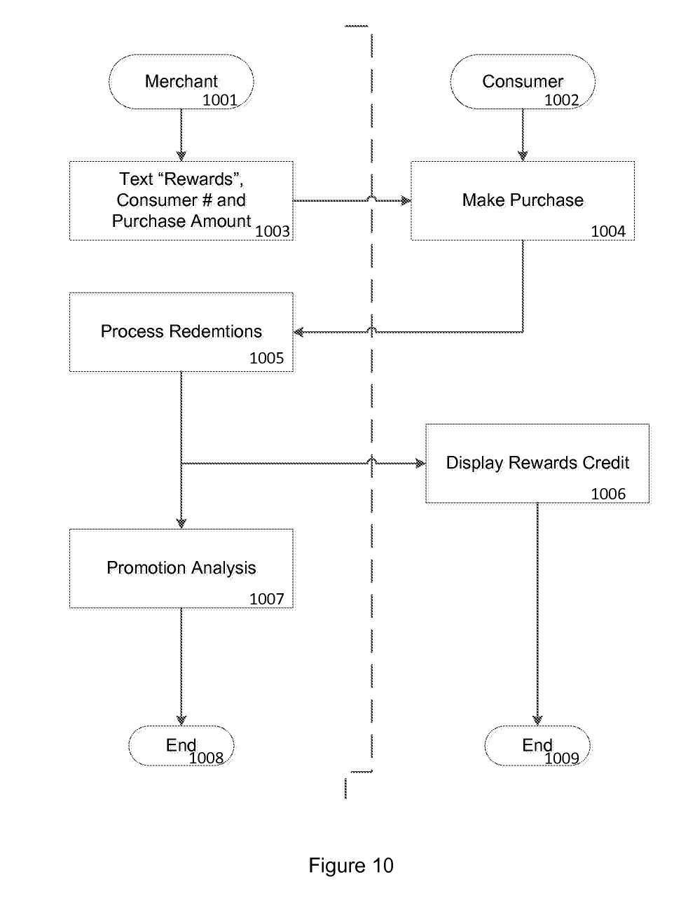

Turning now to FIG. 10, a process flow illustrating an exemplary method, according to an embodiment of the present invention, is shown. The process may be perceived to start at different steps, depending if the starting point is based on a merchant's viewpoint 1001 or a consumer's viewpoint 1002. Based on the merchant's viewpoint 1001, the process begins at step 1003 when the merchant pushes a rewards promotion to a specific user based on (i) a consumer identifier (e.g., consumer number or ID) and (ii) a purchase amount. At step 1004, the user makes a purchase of the corresponding amount or greater. At step 1005, the system processes the redemption of a reward associated with the purchase. At this point, the user is able to view/have displayed a credit for the reward (step 1006) after which the user process terminates (step 1009) and the merchant is capable of analyzing the promotion (step 1007) after which the merchant process terminates (step 1008).

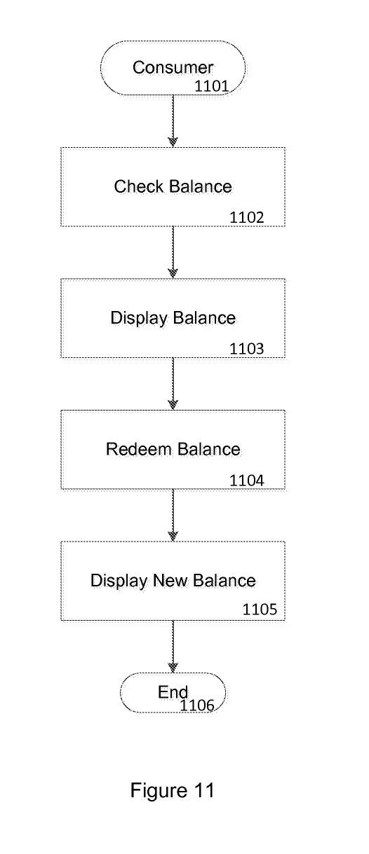

Turning now to FIG. 11, a process flow illustrating an exemplary method, according to an embodiment of the present invention, is shown. The process begins for a consumer at step 1101. At step 1102, the consumer initiates a check balance inquiry to the system. The system then provides a balance to the display of the consumer's computing device (step 1103). At step 1104, the consumer decides to redeem the balance (or a portion thereof). At step 1105, the system provides an updates balance to the consumer and the process ends at step 1106.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing advanced mobile marketing via SMS, said system comprising:
an application server comprising a processor, computer-executable code stored in non-volatile memory and a communications means,
wherein said processor, said computer-executable code and said communications means are operably connected and are configured to:
receive a SMS message received from a SMS messaging provider, wherein said SMS message is comprised of one or more of a short code ID, a merchant ID, a product ID, a label, a keyword and a data message content;
process said SMS message;
generate a response SMS message; and
transmit said response SMS message to one or more recipients.

2. The system of claim 1, wherein said short code ID identifies an action to be taken by said application server.

3. The system of claim 1, wherein said merchant ID identifies a merchant associated with said SMS message.

4. The system of claim 1, wherein said product ID identifies a product associated with said SMS message.

5. The system of claim 1, wherein said label identifies a merchant name.

6. The system of claim 1, wherein said label identifies a product name.

7. The system of claim 1, wherein said keyword identifies an action to be taken by said application server.

8. The system of claim 1, wherein said data message content identifies data associated with said SMS message.

9. The system of claim 1, wherein said response SMS message indicates a response to said SMS message received by said application server.

10. A method for providing advanced mobile marketing via SMS, said method comprising the steps of:
receiving a SMS message, at an application server, received from a SMS messaging provider, wherein said SMS message is comprised of one or more of a short code ID, a merchant ID, a product ID, a label, a keyword and a data message content;
processing said SMS message;
generating a response SMS message; and
transmitting said response SMS message to one or more recipients.

11. The method of claim 10, wherein said short code ID identifies an action to be taken by said application server.

12. The method of claim 10, wherein said merchant ID identifies a merchant associated with said SMS message.

13. The method of claim 10, wherein said product ID identifies a product associated with said SMS message.

14. The method of claim 10, wherein said label identifies a merchant name.

15. The method of claim 10, wherein said label identifies a product name.

16. The method of claim 10, wherein said keyword identifies an action to be taken by said application server.

17. The method of claim 10, wherein said data message content identifies data associated with said SMS message.

18. The method of claim 10, wherein said response SMS message indicates a response to said SMS message received by said application server.
